(19) United States
(12) Patent Application Publication
(10) Pub. No.: US 2014/0258636 A1
(43) Pub. Date: Sep. 11, 2014

(54) CRITICAL-WORD-FIRST ORDERING OF CACHE MEMORY FILLS TO ACCELERATE CACHE MEMORY ACCESSES, AND RELATED PROCESSOR-BASED SYSTEMS AND METHODS

(71) Applicant: QUALCOMM Incorporated, San Diego, CA (US)

(72) Inventor: Xiangyu Dong, La Jolla, CA (US)

(21) Appl. No.: 13/925,874

(22) Filed: Jun. 25, 2013

Related U.S. Application Data
(60) Provisional application No. 61/773,951, filed on Mar. 7, 2013.

(51) Int. Cl. G06F 12/12

(52) U.S. Cl. CPC G06F 12/128
USPC 711/133

(57) ABSTRACT

Critical-word-first reordering of cache fills to accelerate cache memory accesses, and related processor-based systems and methods are disclosed. In this regard in one embodiment, a cache memory is provided. The cache memory comprises a data array comprising a cache line, which comprises a plurality of data entry blocks configured to store a plurality of data entries. The cache memory also comprises cache line ordering logic configured to critical-word-first order the plurality of data entries into the cache line during a cache fill, and to store a cache line ordering index that is associated with the cache line and that indicates the critical-word-first ordering of the plurality of data entries in the cache line. The cache memory also comprises cache access logic configured to access each of the plurality of data entries in the cache line based on the cache line ordering index for the cache line.

### PRIORITY CLAIM

The present application claims priority to U.S. Provisional Patent Application Ser. No. 61/773,951 filed on Mar. 7, 2,013 and entitled “CRITICAL-WORD-FIRST ORDERING IN CACHE MEMORIES TO ACCELERATE CRITICAL-WORD-FIRST CACHE ACCESSES, AND RELATED PROCESSOR-BASED SYSTEMS AND METHODS,” which is incorporated herein by reference in its entirety.

### BACKGROUND

I. Field of the Disclosure

The field of the present disclosure relates to accessing cache memory in processor-based systems.

II. Background

Cache memory may be used by a computer processor, such as a central processing unit (CPU), to reduce average memory access times by storing copies of data from frequently used main memory locations. Cache memory typically has a much smaller storage capacity than a computer's main memory. However, cache memory also has a much lower latency than main memory (i.e., cache memory can be accessed much more quickly by the CPU). Thus, as long as a majority of memory requests by the CPU are made to previously cached memory locations, the use of cache memory will result in an average memory access latency that is closer to the latency of the cache memory than to the latency of the main memory. Cache memory may be integrated into the same computer chip as the CPU itself (i.e., “on-chip” cache memory), serving as an interface between the CPU and off-chip memory. Cache memory may be organized as a hierarchy of multiple cache levels (e.g., L1, L2, or L3 caches), with higher levels in the cache hierarchy comprising smaller and faster memory than lower levels.

While a larger on-chip cache memory may reduce a need for off-chip memory accesses, an increase in on-chip cache memory size also results in increased interconnect latency of the on-chip cache memory. Interconnect latency refers to a delay in retrieving contents of the cache memory due to a physical structure of memory arrays that make up the cache memory. For example, a large on-chip cache memory may comprise a memory array divided into a “fast zone” sub-array that provides a lower interconnect latency and a “slow zone” sub-array that requires a higher interconnect latency. Because of the physical characteristics of the cache memory, retrieval of data entries cached in the slow zone sub-array may require more processor clock pulses than retrieval of data entries stored in the fast zone sub-array. Thus, if a data entry requested from the cache memory (i.e., a “critical word”) is located in the slow zone sub-array, extra interconnect latency is incurred, which has a negative impact on performance of the CPU.

### SUMMARY OF THE DISCLOSURE

Embodiments disclosed herein include critical-word-first ordering of cache memory fills to accelerate cache memory accesses. Related processor-based systems and methods are also disclosed. In embodiments disclosed herein, a plurality of data entries are ordered such that a critical word among the plurality of data entries occupies a first data entry block of a cache line during a cache fill. A cache line ordering index is stored in association with the cache line to indicate an ordering of the plurality of data entries in the cache line based on the critical word being ordered in the first data entry block of the cache line. In this manner, when the cache line in the cache memory is accessed, the cache line ordering index is consulted to determine the ordering of a data entry stored in the cache line based on the cache fill having been critical-word-first ordered. As a non-limiting example, the critical-word-first ordering provided herein can increase data entry block hit rates in slow zone memory sub-arrays, thereby reducing effective cache access latency and improving processor performance.

In this regard in one embodiment, a cache memory is provided. The cache memory comprises a data array comprising a cache line, which comprises a plurality of data entry blocks configured to store a plurality of data entries. The cache memory also comprises cache line ordering logic. The cache line ordering logic is configured to critical-word-first order the plurality of data entries into the cache line during a cache fill. The cache line ordering logic is also configured to store a cache line ordering index associated with the cache line, the cache line ordering index indicating the critical-word-first ordering of the plurality of data entries in the cache line. The cache memory further comprises cache access logic configured to access each of the plurality of data entries in the cache line based on the cache line ordering index for the cache line.

In another embodiment, a cache memory is provided. The cache memory comprises a means for storing a plurality of data entries in a cache line. The cache memory also comprises a cache line ordering logic means. The cache line ordering logic means is configured to critical-word-first order the plurality of data entries into the cache line during a cache fill. The cache line ordering logic means is also configured to store a cache line ordering index associated with the cache line, the cache line ordering index indicating the critical-word-first ordering of the plurality of data entries in the cache line. The cache memory further comprises a cache access logic means configured to access each of the plurality of data entries in the cache line based on the cache line ordering index for the cache line.

In another embodiment, a method of critical-word-first ordering a cache memory fill is provided. The method comprises critical-word-first ordering a plurality of data entries into a cache line during a cache fill. The method also comprises storing a cache line ordering index associated with the cache line, the cache line ordering index indicating the critical-word-first ordering of the plurality of data entries in the cache line. The method further comprises accessing each of the plurality of data entries in the cache line based on the cache line ordering index for the cache line.

### BRIEF DESCRIPTION OF THE FIGS.

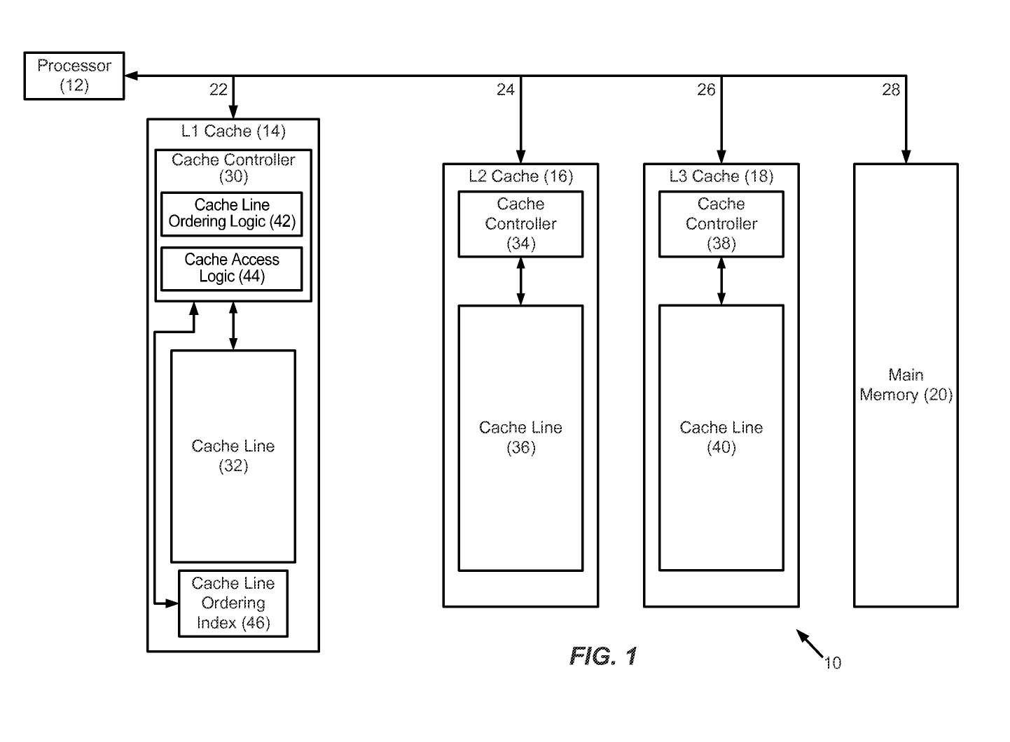

FIG. 1 illustrates an exemplary central processing unit (CPU) providing critical-word-first ordering of cache memory fills to accelerate cache memory accesses;

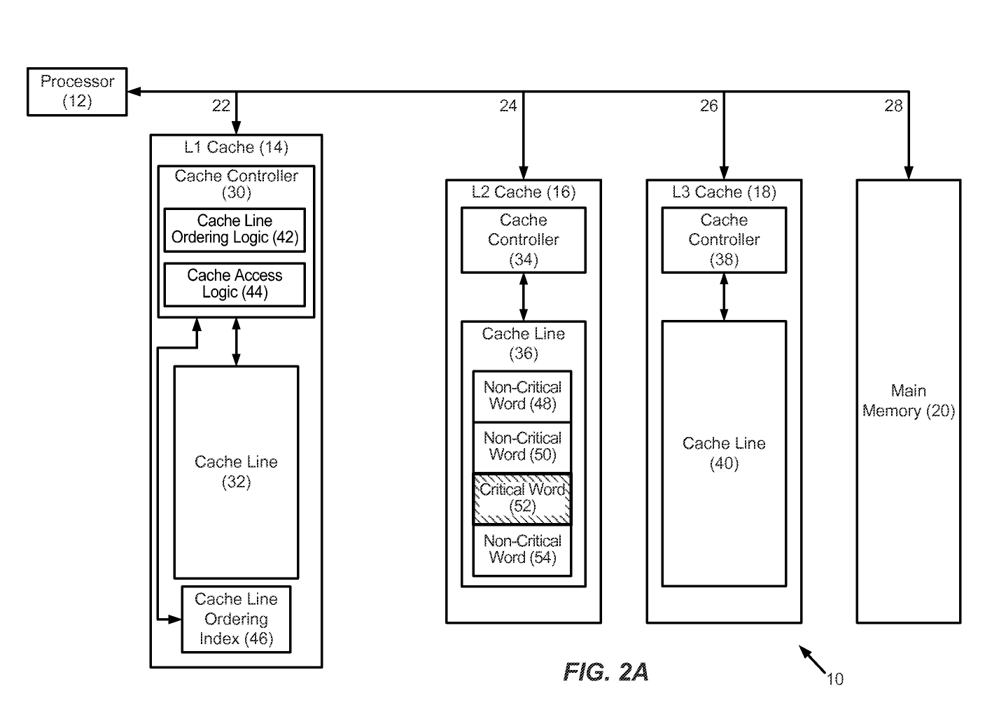

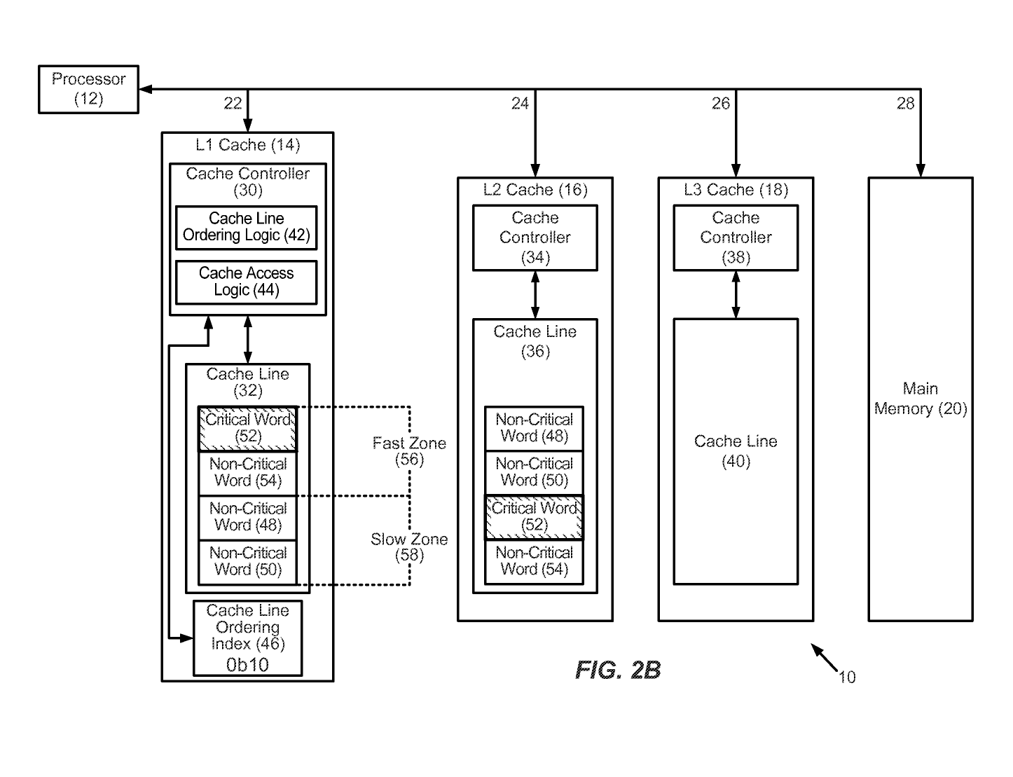

FIGS. 2A and 2B are diagrams illustrating contents of L1 and L2 caches of the CPU of FIG. 1 before and after a critical-word-first ordering of a cache memory fill;

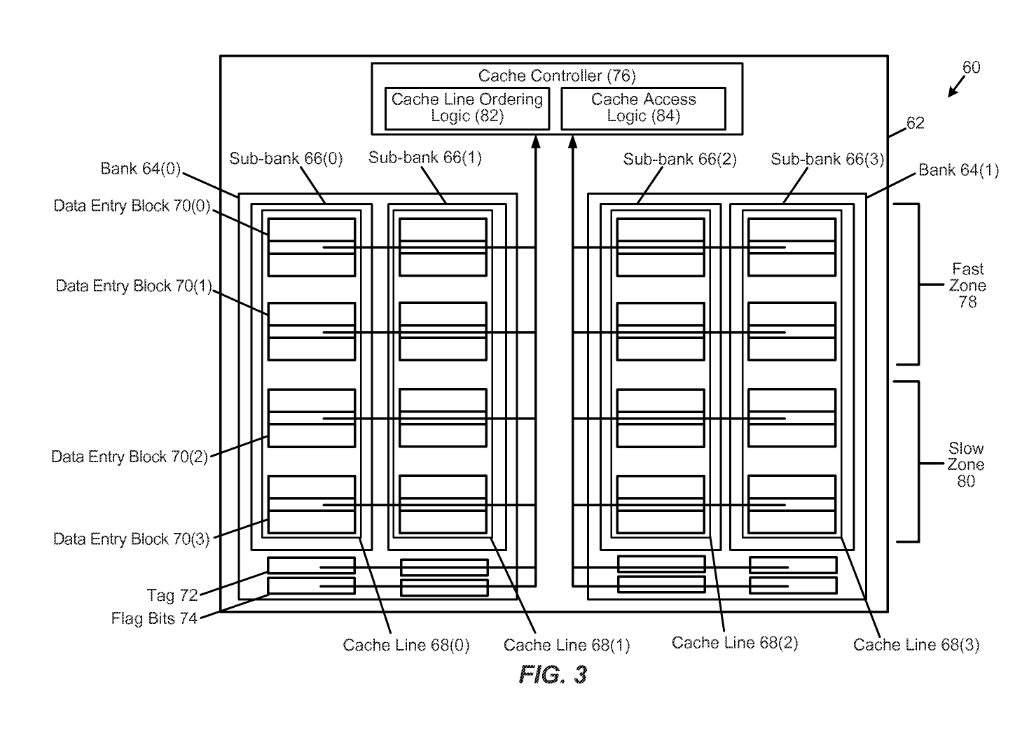

FIG. 3 illustrates an exemplary cache memory arranged in sub-arrays;

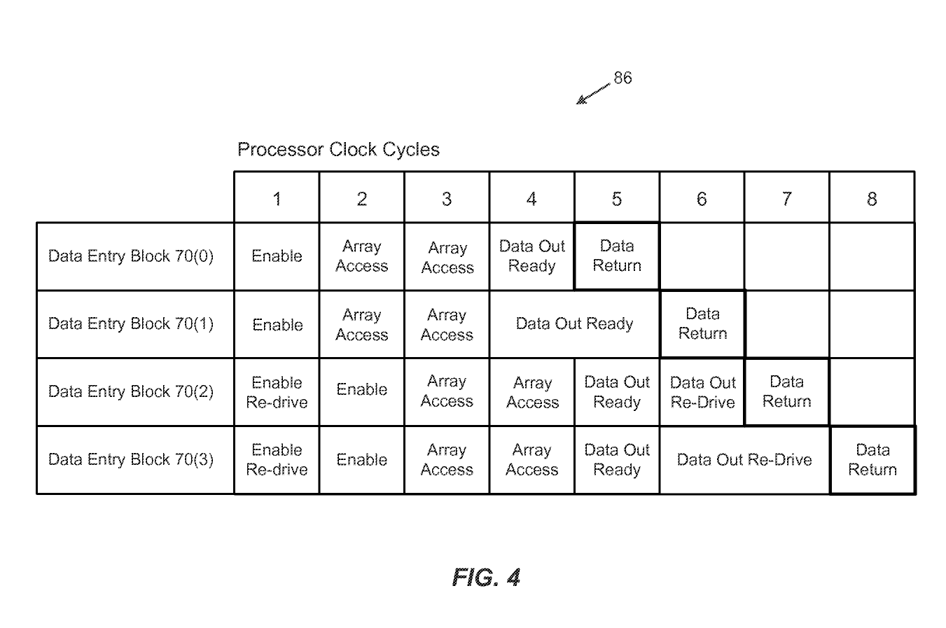

FIG. 4 illustrates an exemplary clock cycle chart showing cache accesses to “fast zone” and “slow zone” sub-arrays of the cache memory of FIG. 3;

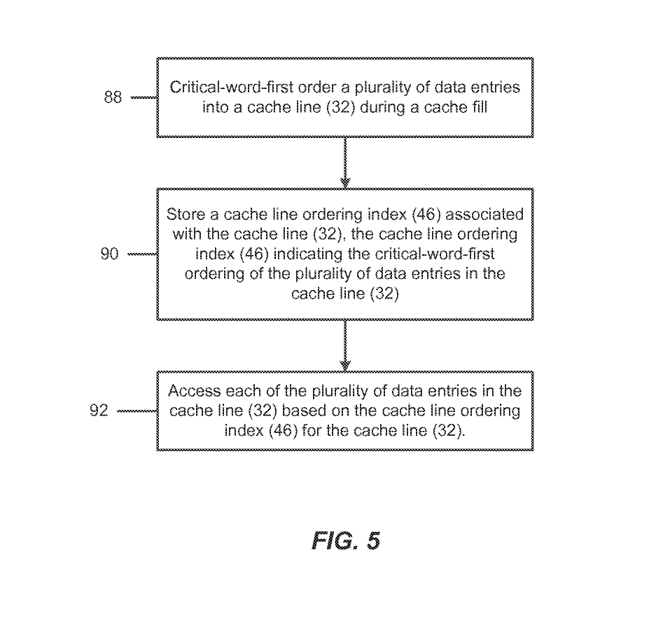

FIG. 5 is a flowchart showing exemplary operations for critical-word-first ordering of cache fills to accelerate cache memory accesses;

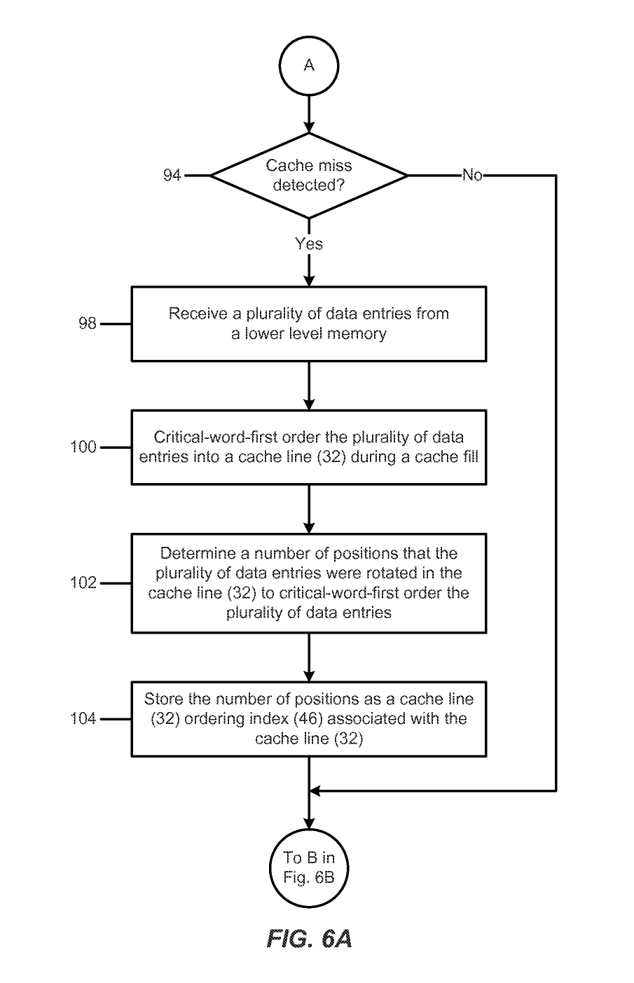

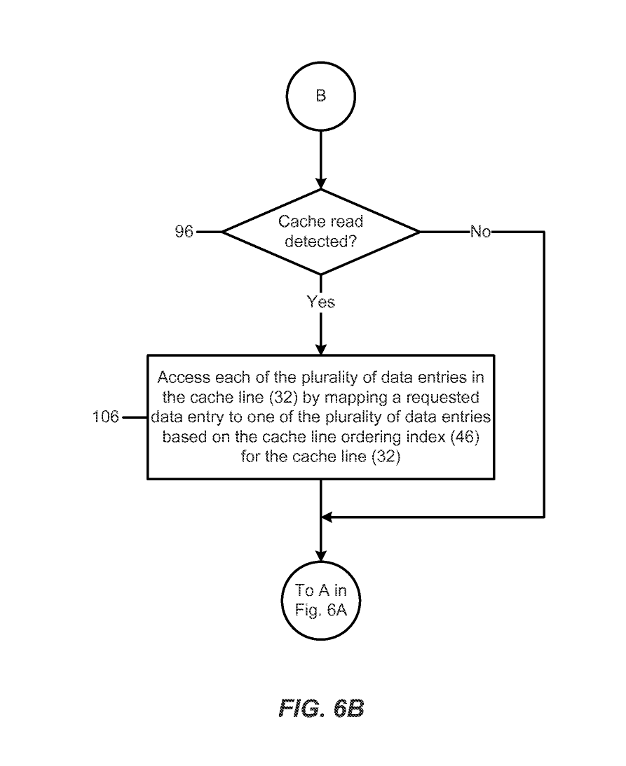

FIGS. 6A and 6B are flowcharts illustrating, in greater detail, exemplary operations for receiving and critical-word-first ordering a plurality of data entries of a cache fill for a cache line; and

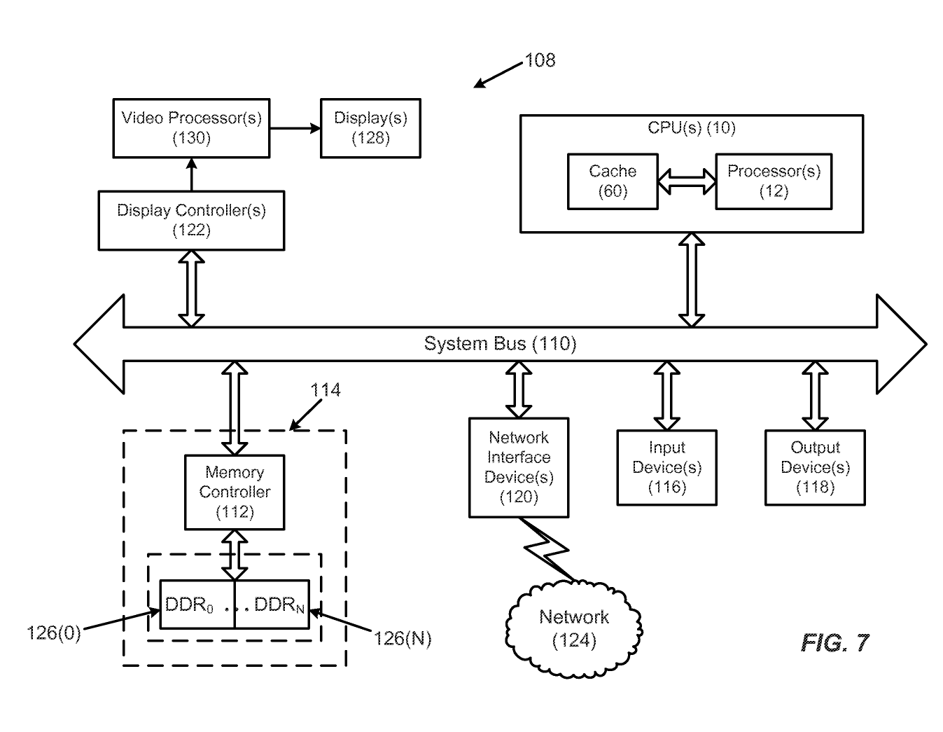

FIG. 7 is a block diagram of an exemplary processor-based system that can include the cache memory of FIG. 3 for critical-word-first ordering data entries during cache fills to accelerate cache memory accesses, according to any of the embodiments described herein.

### DETAILED DESCRIPTION

With reference now to the drawing figures, several exemplary embodiments of the present disclosure are described. The term “exemplary” is used herein to mean “serving as an example, instance, or illustration.” Any embodiment described herein as “exemplary” is not necessarily to be construed as preferred or advantageous over other embodiments.

Embodiments disclosed herein include critical-word-first ordering of cache memory fills to accelerate cache memory accesses. Related processor-based systems and methods are also disclosed. In embodiments disclosed herein, a plurality of data entries are ordered such that a critical word among the plurality of data entries occupies a first data entry block of a cache line during the cache fill. A cache line ordering index is stored in association with the cache line to indicate an ordering of the plurality of data entries in the cache line based on the critical word being ordered in the first data entry block of the cache line. In this manner, when the cache line in the cache memory is accessed, the cache line ordering index is consulted to indicate the ordering of a data entry stored in the cache line based on the cache fill having been critical-word-first ordered. As a non-limiting example, the critical-word-first ordering provided herein can increase data entry block hit rates in “slow zone” memory sub-arrays, thereby reducing effective cache access latency and improving processor performance.

In this regard in one embodiment, a cache memory is provided. The cache memory comprises a data array comprising a cache line, which comprises a plurality of data entry blocks configured to store a plurality of data entries. The cache memory also comprises cache line ordering logic. The cache line ordering logic is configured to critical-word-first order the plurality of data entries into the cache line during a cache fill. The cache line ordering logic is also configured to store a cache line ordering index associated with the cache line, the cache line ordering index indicating the critical-word-first ordering of the plurality of data entries in the cache line. The cache memory further comprises cache access logic configured to access each of the plurality of data entries in the cache line based on the cache line ordering index for the cache line.

In this regard, FIG. 1 illustrates an exemplary central processing unit (CPU) 10 including a cache memory providing critical-word-first ordering of cache memory fills to accelerate cache memory accesses. In FIG. 1, the exemplary CPU 10 includes a processor 12 that is communicatively coupled to cache memories including an L1 cache 14, an L2 cache 16, and an L3 cache 18, as well as a main memory 20, as indicated by bidirectional arrows 22, 24, 26, and 28, respectively. The L1 cache 14, the L2 cache 16, the L3 cache 18, and the main memory 20 collectively represent a hierarchy of memories, with the L1 cache 14 at the top of the hierarchy, and the main memory 20 at the bottom of the hierarchy. Higher levels of the hierarchy (e.g., the L1 cache 14) provide faster access to stored data, but are smaller in size. Conversely, lower levels of the hierarchy (e.g., the main memory 20) have larger storage capacities, but comparatively greater access latencies.

The L1 cache 14 of FIG. 1 includes a cache controller 30, which provides a communications interface controlling the flow of data between the L1 cache 14 and the processor 12. The L1 cache 14 also provides a cache line 32 for storing data received from a lower level cache and/or from the main memory 20. The L2 cache 16 likewise includes a cache controller 34 and a cache line 36. The L3 cache 18 includes a cache controller 38 and a cache line 40. It is to be understood that each of the L1 cache 14, the L2 cache 16, and the L3 cache 18 is depicted in FIG. 1 as having one cache line 32, 36, 40 for the sake of clarity. The configuration illustrated in FIG. 1 is for illustrative purposes only, and in some embodiments the CPU 10 may comprise additional or fewer levels of cache memory than the L1 cache 14, the L2 cache 16, and the L3 cache 18 illustrated herein. Additionally, in some embodiments the L1 cache 14, the L2 cache 16, and the L3 cache 18 may comprise more cache lines 32, 36, and/or 40 than illustrated herein.

With continuing reference to FIG. 1, the cache controller 30 of the L1 cache 14 includes cache line ordering logic 42 and cache access logic 44. As discussed in greater detail below, the cache line ordering logic 42 is configured to critical-word-first order a plurality of data entries (not shown) into the cache line 32 during a cache fill. The cache line ordering logic 42 is also configured to store a cache line ordering index 46 that is associated with the cache line 32 and that indicates the critical-word-first ordering of the plurality of data entries in the cache line 32. The cache access logic 44 is configured to access the plurality of data entries in the cache line 32 based on the cache line ordering index 46 for the cache line 32.

To illustrate a cache fill including critical-word-first ordering of a plurality of data entries into the cache line 32 of the L1 cache 14, FIGS. 2A and 2B are provided. FIG. 2A shows the contents of the L1 cache 14 and the L2 cache 16 of FIG. 1 when a critical word is requested from the L1 cache 14 by the processor 12 (thus triggering the cache fill). FIG. 2B illustrates a result of critical-word-first ordering the plurality of data entries in the cache line 32 of the L1 cache 14 after the cache fill is complete.

In FIG. 2A, the cache line 36 of the L2 cache 16 contains a total of four data entries: a non-critical word 48, a non-critical word 50, a critical word 52, and a non-critical word 54. It is to be assumed that the data entries in the cache line 36 were stored in the L2 cache 16 during a previous cache fill operation (not shown). In this example, the cache line 32 of the L1 cache 14 may be empty, or may contain previously cached data entries (not shown). At this point, the processor 12 requests the critical word 52 from the L1 cache 14 for processing. A “critical word,” as used herein, is a specific data entry stored at a particular memory location and requested by a requesting entity, such as a processor or a higher-level cache, for example. Because the critical word 52 is not currently stored in the L1 cache 14, a cache miss results. In response to the cache miss, the L2 cache 16 is queried, and the critical word 52 is determined to be located in the cache line 36 of the 112 cache 16. An operation referred to as a “cache fill” then begins, during which the contents of the cache line 36 of the L2 cache 16 are retrieved for storage in the cache line 32 of the L1 cache 14.

Referring now to FIG. 2B, the cache line 32, of the L1 cache 14 may be divided into a fast zone 56 and a slow zone 58. Due to a physical characteristic of the L1 cache 14 discussed in greater detail below, data entries stored in the fast zone 56 may be retrieved using fewer processor clock cycles than data entries stored in the slow zone 58. As non-limiting examples, the data entries in the fast zone 56 may be physically stored closer to the cache controller 30 than the data entries in the slow zone 58, and/or the data entries in the fast zone 56 may be stored in memory having a shorter react/write access latency than the memory storing the data entries in the slow zone 58. Accordingly, if the contents of the cache line 36 of the L2 cache 16 were stored in the same order in the cache line 32 of the L1 cache 14 during the cache fill, the critical word 52 would be stored in the slow zone 58. If and when the critical word 52 is subsequently retrieved from the L1 cache 14, extra interconnect latency will be incurred. This may cause a decrease in processor performance by forcing the processor 12 to remain idle for multiple processor clock cycles while the critical word 52 is retrieved.

Accordingly, the cache controller 30 of the L1 cache 14 of FIG. 2B provides the cache line ordering logic 42 to critical-word-first reorder the data entries to be stored in the cache line 32 during the cache fill. As seen in FIG. 2B, the cache line ordering logic 42 has rotated the positions of the data entries in the cache line 32 by two positions, resulting in the critical word 52 being stored the fast zone 56 of the cache line 32. The position of the non-critical word 54 has also been rotated into the fast zone 56, while the positions of the non-critical words 48 and 50 have “wrapped around” the cache line 32 into the slow zone 58. The cache line ordering logic 42 stores a binary value 0b10 (i.e., a decimal value of 2) as the cache line ordering index 46. In this example, the cache line ordering index 46 indicates how many positions the data entries stored in the cache line 32 have been rotated in the cache line 32. The cache access logic 44 of the cache controller 30 may use the value of the cache line ordering index 46 to subsequently access the data entries stored in the cache line 32 without having to rotate or otherwise modify the positions of the data entries in the cache line 32. By placing the critical word 52 in the fast zone 56 of the cache line 32, decreased interconnect latency and improved processor performance may be achieved.

FIG. 3 is provided to illustrate a structure of an exemplary cache memory 60. The cache memory 60 may be provided in a semiconductor die 62. In some embodiments, the cache memory 60 may be the L1 cache 14, the L2 cache 16, or the L3 cache 18 of FIG. 1, among others, in a hierarchy of memories. In this example, the cache memory 60 is a memory array organized into two banks 64(0) and 64(1). Each of the banks 64(0) and 64(1) comprises two sub-banks, with the bank 64(0) including sub-banks 66(0) and 66(1), and the bank 64(1) including sub-banks 66(2) and 66(3). The sub-banks 66(0)-66(3) correspond to cache lines 68(0)-68(3), respectively. Each of the sub-banks 66(0)-66(3) contains four data entry blocks 70(0)-70(3). In this example, the data entry blocks 70(0)-70(3) each store a 16-byte group of four data entries (not shown). Accordingly, each of the cache lines 68(0)-68(3) stores 64 bytes of data received from a main memory or a lower-level cache (not shown). Each of the cache lines 68(0)-68(3) also includes a tag 72 and flag bits 74. The tag 72 may contain part or all of a memory address (not shown) from which cached data stored in a corresponding cache line 68 was fetched, while the flag bits 74 may include flags, such as a validity flag and/or a dirty flag (not shown).

It is to be understood that embodiments described herein are not restricted to any particular arrangement of elements, and the disclosed techniques may be easily extended to various structures and layouts of the cache memory 60. The configuration illustrated in FIG. 3 is for illustrative purposes only, and in some embodiments the cache memory 60 may comprise fewer or more banks 64, sub-banks 66, data entry blocks 70, and/or cache lines 68 than illustrated herein. Some embodiments of the cache memory 60 may utilize data entries of larger or smaller size than the exemplary 4-byte date entries described herein, and/or cache lines 68 of larger or smaller size than the exemplary 64-byte cache lines 68 described herein.

With continued reference to FIG. 3, a cache controller 76 is connectively coupled to each data entry block 70(0)-70(3) of each sub-bank 66(0)-66(3). In the example in FIG. 3, the data entry blocks 70(2) and 70(3) are physically situated farther from the cache controller 76 than the data entry blocks 70(0) and 70(1). As a result, a data entry stored in the data entry blocks 70(0) or 70(1) may be read or written in fewer processor clock cycles than a data entry stored in the data entry blocks 70(2) or 70(3). For example, in some embodiments discussed below with respect to FIG. 4, only three clock cycles may be required to access a data entry stored in the data entry blocks 70(0) or 70(1), while five clock cycles may be required to access a data entry stored in the data entry blocks 70(2) or 70(3). For this reason, the data entry blocks 70(0) and 70(1) are considered to reside in a fast zone 78 of the cache memory 60, and the data entry blocks 70(2) and 70(3) reside in a slow zone 80 of the cache memory 60.

It is to be understood that a physical characteristic other than the physical location of the data entry blocks 70 relative to the cache controller 76 may result in a given data entry block 70 being considered to reside in the fast zone 78 or the slow zone 80. As a non-limiting example, the data entry blocks 70(0) and 70(1) in the fast zone 78 may comprise static random-access memory (SRAM). In contrast, the data entry blocks 70(2) and 70(3) in the slow zone 80 may comprise magnetoresistive random access memory (MRAM), which has a higher read/write access latency compared to SRAM,

As discussed above, a requesting entity (e.g., the processor 12 of FIG. 1 or a higher-level cache) may request a critical word, such as the critical word 52 of FIGS. 2A and 2B, for processing. If the critical word is not found in the cache memory 60, a cache miss results. In response, a cache fill causes a portion of memory equal to the size of a cache line 68 and containing the critical word to be retrieved and stored in one of the cache lines 68(0)-68(3). After the cache fill operation is complete, the critical word may be stored in the fast zone 78 (i.e., one of the data entry blocks 70(0) or 70(1) of one of the cache lines 68(0)-68(3)) or in the slow zone 80 (one of the data entry blocks 70(2) or 70(3) of one of the cache lines 68(0)-8(3)). If the critical word is stored in the slow zone 80, the cache memory 60 will incur extra interconnect latency if and when the critical word is subsequently retrieved from the cache memory 60. This may cause a decrease in processor performance by forcing the processor, such as the processor 12 of FIGS. 1-2B, to remain idle for multiple processor clock cycles while the critical word is retrieved.

Thus, the cache controller 76 of the cache memory 60 provides cache line ordering logic 82 that is configured to critical-word-first order a plurality of data entries during the cache fill. The cache line ordering logic 82 is further configured to store a cache line ordering index (not shown) that is associated with a cache line 68, and that indicates the critical-word-first ordering of the plurality of data entries in the cache line 68. In some embodiments, the cache line ordering index is stored in the tag 72 associated with the cache line 68, and/or in the flag bits 74 associated with the cache line 68. In this manner, placement of a critical word in a cache line 68 in the fast zone 78 of the cache memory 60 may be ensured, resulting in decreased interconnect latency and improved processor performance.

The cache controller 76 of the cache memory 60 also provides cache access logic 84, which is configured to access the plurality of data entries in the cache line 68 based on the cache line ordering index associated with the cache line 68. For example, some embodiments may provide that the cache access logic 84 is configured to map a requested data entry to one of the plurality of data entries of the cache line 68 based on the cache line ordering index for the cache line 68. Thus, the cache access logic 84 may access the plurality of data entries without requiring the cache line 68 to be reordered.

FIG. 4 is provided to more clearly illustrate how the zone in which a critical word is stored during a cache fill operation (i.e., the fast zone 78 or the slow zone 80) may affect an interconnect latency, and thus the total cache access latency, of the cache memory 60 of FIG. 3. FIG. 4 illustrates a clock cycle chart 86 showing exemplary operations for accessing each of the data entry blocks 70(0)-70(3) of one of the cache lines 68(0)-68(3) of FIG. 3. As noted above, the data entry blocks 70(0) and 70(1) are located in the fast zone 78 of the cache memory 60, while the data entry blocks 70(2) and 70(3) are located in the slow zone 80 of the cache memory 60. In FIG. 4, each of the columns in the clock cycle chart 86 (labeled 1, 2, . . . 8) represents a single processor clock cycle. The rows in the clock cycle chart 86 (labeled “Data Entry Block 70(0),” “Data. Entry Block 70(1),” “Data Entry Block 70(2),” and “Data Entry Block 70(3)”) indicate the operations occurring with respect to each data entry block 70(0)-70(3) during each processor clock cycle. In this manner, the sequence of cache memory access operations over the course of several clock cycles is shown. For the sake of clarity, elements of FIG. 3 are referenced in describing the exemplary operations shown in FIG. 4.

As illustrated in FIG. 4, processing begins at processor clock cycle 1 with the data entry blocks 70(0) and 70(1) in the fast zone 78 each receiving an Enable signal from the cache controller 76. An Enable signal is also dispatched to each of the data entry blocks 70(2) and 70(3) in the slow zone 80. In this example, because of the distance between the data entry blocks 70(2) and 70(3) and the cache controller 76, the Enable signals do not reach the slow zone 80 in one processor clock cycle. Consequently, an Enable Re-drive operation is required during processor clock cycle 1 to send the Enable signal to the data entry blocks 70(2) and 70(3).

During processor clock cycle 2, an Array Access operation for accessing the contents of the data entry blocks 70 begins for each of the data entry blocks 70(0) and 70(1). At the same time, the previously dispatched Enable signal reaches the slow zone 80 and is received by each of the data entry blocks 70(2) and 70(3). At this point, the interconnect latency for the data entry blocks 70(2), 70(3) in the slow zone 80 is one processor clock cycle longer than the interconnect latency for the data entry blocks 70(0), 70(1) in the fast zone 78.

In processor clock cycle 3 of FIG. 4, the Array Access operation for each of the data entry blocks 70(0) and 70(1) continues, while the Array Access operation for each of the data entry blocks 70(2) and 70(3) begins simultaneously. During processor clock cycle 4, the contents of both data entry blocks 70(0) and 70(1) are sent to the cache controller 76, resulting in a status of Data Out Ready. Concurrently, the Array Access operation for each of the data entry blocks 70(2) and 70(3) continues.

During processor clock cycle 5, data from either data entry block 70(0) or data entry block 70(1) may be returned (e.g., to the requesting processor, such as the processor 12 of FIGS. 1-2B, or to a higher-level cache). In this example, data from the data entry block 70(0) is returned in processor clock cycle 5, and data from the data entry block 70(1) is returned in processor clock cycle 6. However, because the data entry blocks 70(0) and 70(1) both reach a status of Data Out Ready during the same processor clock cycle 4, the order of memory access may be reversed. Thus, in some embodiments, data from the data entry block 70(1) may be returned in processor clock cycle 5, and data from the data entry block 70(0) may be returned in processor clock cycle 6.

Also during the processor clock cycle 5 of FIG. 4, the contents of both data entry blocks 70(2) and 70(3) are sent to the cache controller 76, and reach a status of Data Out Ready. Because of the distance between the data entry blocks 70(2) and 70(3) and the cache controller 76 in this example, the data does not reach the cache controller 76 from the slow zone 80 in one processor clock cycle. Consequently, a Data Out Re-drive operation is required during processor clock cycle 6 to send the data to the cache controller 76.

At processor clock cycle 7, data from either data entry block 70(2) or data entry block 70(3) may be returned (e.g., to a requesting processor or higher-level cache). In FIG. 4, data from the data entry block 70(2) is returned in processor clock cycle 7, and data from the data entry block 70(3) is returned in processor clock cycle 8. However, because the data entry blocks 70(2) and 70(3) both reach a status of Data Out Ready during the same processor clock cycle 5, the order of memory access may be reversed in some embodiments. Accordingly, some embodiments may provide that data from the data entry block 70(3) is returned in processor clock cycle 7, and data from the data entry block 70(2) is returned in processor clock cycle 8.

As seen in FIG. 4, the additional Enable Re-drive and Data Out Re-drive operations required for the data entry blocks 70(2) and 70(3) result in an increased interconnect latency for the data entry blocks 70 in the slow zone 80. In this example, the interconnect latency for the data entry blocks 70(0) and 70(1), from receiving the Enable signal until reaching the Data Out Ready status, consists of three processor clock cycles. In contrast, the interconnect latency for the data entry blocks 70(2) and 70(3), from the Enable Re-drive operation until the Data Out Re-drive operation, consists of five processor clock cycles. Thus, the interconnect latency for the data entry blocks 70(2) and 70(3) is two processor clock cycles longer than the interconnect latency for the data entry blocks 70 in the fast zone 78. By critical-word-first ordering the data entries in the data entry blocks 70(0)-70(3) during a cache fill, the excess interconnect latency may be avoided, accelerating subsequent cache accesses and improving processor performance.

In this regard, FIG. 5 is provided to illustrate exemplary operations carried out by the cache line ordering logic 42 and the cache access logic 44 of the cache controller 30 of FIG. 1 to accelerate cache memory accesses. In FIG. 5, operations begin with the cache line ordering logic 42 critical-word-first ordering a plurality of data entries into a cache line, such as the cache line 32 of FIG. 1, during a cache fill (block 88). In some embodiments, the critical word may be a data entry requested by a processor and/or by a higher-level ache memory, for example.

The cache line ordering logic 42 next stores a cache line ordering index (e.g., the cache line ordering index 46 of FIG. 1) associated with the cache line 32 (block 90). The cache line ordering index 46 indicates the critical-word-first ordering of the plurality of data entries in the cache line 32. Some embodiments may provide that the cache line ordering index 46 is stored in the tag 72 of FIG. 3 associated with the cache line 68(0), or in the flag bits 74 of the cache line 68(0). In some embodiments, the cache line ordering index 46 may indicate a number of positions in the cache line 32 that the plurality of data entries was rotated to critical-word-first order the plurality of data entries. The cache access logic 44 then accesses each of the plurality of data entries in the cache line 32 based on the cache line ordering index 46 for the cache line 32 (block 94). In some embodiments, accessing each of the plurality of data entries in the cache line 32 includes mapping a requested data entry (i.e., a data entry requested during a cache read) to one of the plurality of the data entries based on the cache line ordering index 46 for the cache line 32.

More detailed exemplary operations carried out by the cache line ordering logic 42 and the cache access logic 44 of the cache controller 30 of FIG. 1 are illustrated in FIGS. 6A and 6B. FIG. 6A is a flowchart illustrating exemplary operations for receiving and critical-word-first ordering a cache fill responsive to a cache miss. FIG. 6B is a flowchart showing exemplary operations for accessing critical-word-first ordered data entries on a cache read.

In FIG. 6A, the cache line ordering logic 42 first determines whether a cache miss has been detected (block 94). If not, processing proceeds to block 96 of FIG. 6B. If a cache miss is detected at block 94 of FIG. 6A, the cache line ordering logic 42 receives a plurality of data entries from a lower level memory (block 98). In some embodiments, the lower level memory may be a lower level cache, such as the L2 cache 16 and/or the L3 cache 18 of FIG. 1. Some embodiments may provide that the lower level memos is a main memory, such as the main memory 20 of FIG. 1.

The cache line ordering logic 42 next critical-word-first orders the plurality of data entries into a cache line (such as the cache line 32 of the L1 cache 14 of FIG. 1) during a cache fill (block 100). In some embodiments, the critical word is a data entry requested by a processor and/or by a higher-level cache memory, for example. The cache line ordering logic 42 then determines a number of positions in the cache line 32 that the plurality of data entries were rotated to critical-word-first order the plurality of data entries (block 102). The cache line ordering logic 42 stores the number of positions as a cache line ordering index associated with the cache line 32, such as the cache line ordering index 46 of FIG. 1 (block 104). Some embodiments may provide that the cache line ordering index 46 is stored in a tag, such as the tag 72 of FIG. 3, and/or in flag bits such as the flag bits 74 of FIG. 3. Processing then continues at block 96 of FIG. 6B.

Referring now to FIG. 6B, the cache controller 30 next determines whether a cache read has been detected (block 96). If not, processing returns to block 94 of FIG. 6A. If a cache read is detected at block 96 of FIG. 6B, the cache access logic 44 of the cache controller 30 accesses each of the plurality of data entries in the cache line 32 (block 106). To access the plurality of data entries, the cache access logic 44 may map a requested data entry to one of the plurality of data entries based on the cache line ordering index 46 for the cache line 32. This may permit access to the plurality of data entries without requiring another reordering or resorting of the plurality of data entries. Processing then resumes at block 94 of FIG. 6A.

Critical-word-first ordering a cache memory fill to accelerate cache memory accesses according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

In this regard, FIG. 7 is a block diagram of an exemplary processor-based system 108 that can include the cache memory 60 of FIG. 3 configured to reorder cache fills into a critical-word-first ordering to accelerate cache memory accesses, according to any of the embodiments described herein. In this example, the processor-based system 108 includes one or more CPUs 10, each including one or more processors 12. The CPU(s) 10 may have the cache memory 60 coupled to the processor(s) 12 for rapid access to temporarily stored data. The CPU(s) 10 is coupled to a system bus 110 and can intercouple master and slave devices included in the processor-based system 108. As is well known, the CPU(s) 10 communicates with these other devices by exchanging address, control, and data information over the system bus 110. For example, the CPU(s) 10 can communicate bus transaction requests to a memory controller 112 as an example of a slave device.

Other master and slave devices can be connected to the system bus 110. As illustrated in FIG. 7, these devices can include a memory system 114, one or more input devices 116, one or more output devices 118, one or more network interface devices 120, and one or more display controllers 122, as examples. The input device(s) 116 can include any type of input device, including but not limited to input keys, switches, voice processors, etc. The output device(s) 118 can include any type of output device, including but not limited to audio, video, other visual indicators, etc. The network interface device(s) 120 can be any devices configured to allow exchange of data to and from a network 124. The network 124 can be any type of network, including but not limited to a wired or wireless network, a private or public network, a local area network (LAN), a wide local area network (WLAN), and the Internet. The network interface device(s) 120 can be configured to support any type of communication protocol desired. The memory system 114 can include one or more memory units 126(0-N).

The CPU(s) 10 may also be configured to access the display controller(s) 122 over the system bus 110 to control information sent to one or more displays 128. The display controller(s) 122 sends information to the display(s) 128 to be displayed via one or more video processors 130, which process the information to be displayed into a format suitable for the display(s) 128. The display(s) 128 can include any type of display, including but not limited to a cathode ray tube (CRT), a liquid crystal display (LCD), a plasma display, etc.

Those of skill in the art, will further appreciate that the various illustrative logical blocks, modules, circuits, and algorithms described in connection with the embodiments disclosed herein may be implemented as electronic hardware instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a Digital Signal Processor (DSP), an Application Specific Integrated Circuit (ASIC), a Field-Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A cache memory, comprising:
a data array comprising a cache line comprising a plurality of data entry blocks configured to store a plurality of data entries;
cache line ordering logic configured to:
critical-word-first order the plurality of data entries into the cache line during a cache fill; and
store a cache line ordering index associated with the cache line, the cache line ordering index indicating the critical-word-first ordering of the plurality of data entries in the cache line; and
cache access logic configured to access each of the plurality of data entries in the cache line based on the cache line ordering index for the cache line.

2. The cache memory of claim 1, wherein the cache line ordering logic is configured to store the cache line ordering index by:
determining a number of positions in the cache line that the plurality of data entries were rotated to critical-word-first order the plurality of data entries; and
storing the number of positions as the cache line ordering index.

3. The cache memory of claim 1, wherein the cache access logic is configured to access each of the plurality of data entries in the cache line by mapping a requested data entry to one of the plurality of data entries based on the cache line ordering index for the cache line.

4. The cache memory of claim 1, wherein the cache line ordering logic is further configured to critical-word-first order the plurality of data entries responsive to a cache miss.

5. The cache memory of claim 1, wherein the cache line ordering logic is further configured to receive the plurality of data entries originating from a lower level memory.

6. The cache memory of claim 1, further comprising a tag corresponding to the cache line;
wherein the cache line ordering logic is configured to store the cache line ordering index associated with the cache line in the tag corresponding to the cache line.

7. The cache memory of claim 1, further comprising at least one flag bit corresponding to the cache line;
wherein the cache line ordering logic is configured to store the cache line ordering index associated with the cache line in the at least one flag bit corresponding to the cache line.

8. The cache memory of claim 1 integrated into a semiconductor die.

9. The cache memory of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

10. A cache memory, comprising:
a means for storing a plurality of data entries in a cache line;
a cache line ordering logic means configured to:
critical-word-first order the plurality of data entries into the cache line during a cache fill; and
store a cache line ordering index associated with the cache line, the cache line ordering index indicating the critical-word-first ordering of the plurality of data entries in the cache line; and
a cache access logic means configured to access each of the plurality of data entries in the cache line based on the cache line ordering index for the cache line.

11. The cache memory of claim 10, wherein the cache line ordering logic means is configured to store the cache line ordering index by:
determining a number of positions in the cache line that the plurality of data entries were rotated to critical-word-first order the plurality of data entries; and
storing the number of positions as the cache line ordering index.

12. The cache memory of claim 10, wherein the cache access logic means is configured to access each of the plurality of data entries in the cache line by mapping a requested data entry to one of the plurality of data entries based on the cache line ordering index for the cache line.

13. The cache memory of claim 10, wherein the cache line ordering logic means is further configured to critical-word-first order the plurality of data entries responsive to a cache miss.

14. A method of critical-word-first ordering a cache memory fill, comprising:
critical-word-first ordering a plurality of data entries into a cache line during a cache fill;
storing a cache line ordering index associated with the cache line, the cache line ordering index indicating the critical-word-first ordering of the plurality of data entries in the cache line; and
accessing each of the plurality of data entries in the cache line based on the cache line ordering index for the cache line.

15. The method of claim 14, wherein storing the cache line ordering index comprises:
determining a number of positions in the cache line that the plurality of data entries were rotated to critical-word-first order the plurality of data entries; and
storing the number of positions as the cache line ordering index.

16. The method of claim 14, wherein accessing each of the plurality of data entries in the cache line comprises mapping a requested data entry to one of the plurality of data entries based on the cache line ordering index for the cache line.

17. The method of claim 14, wherein critical-word-first ordering the plurality of data entries comprises critical-word-first ordering the plurality of data entries responsive to a cache miss.

18. The method of claim 14, further comprising receiving the plurality of data entries from a lower level memory.

19. The method of claim 14, wherein storing the cache line ordering index comprises storing the cache line ordering index in a tag corresponding to the cache line.

20. The method of claim 14, wherein storing the cache line ordering index comprises storing the cache line ordering index in at least one flag bit corresponding to the cache line.
